(19) United States
(12) Patent Application Publication
(10) Pub. No.: US 2022/0185709 A1
(43) Pub. Date: Jun. 16, 2022

(54) WATER DISINFECTION DEVICES AND METHODS

(71) Applicant: EEnotech, Inc., Sunnyvale, CA (US)

(72) Inventors: Yuanqing Li, Santa Clara, CA (US); Bofei Liu, Santa Clara, CA (US); Yu Zhu, Sunnyvale, CA (US); Sidi Huang, San Jose, CA (US)

(21) Appl. No.: 17/117,927

(22) Filed: Dec. 10, 2020

(51) Int. Cl. C02F 1/461

(52) U.S. Cl. CPC C02F 1/46109; C02F 2001/46133; C02F 2001/46161

(57) ABSTRACT

Water disinfection devices and methods are disclosed. In general, one aspect disclosed features an apparatus comprising: a power source configured to supply power to at least two planar electrodes enclosed in a water filtering apparatus, wherein the power source is configured to provide a fixed voltage to the at least two planar electrodes.

### CROSS REFERENCE TO RELATED APPLICATIONS

The present application is related to U.S. Patent Application No. TBD, filed concurrently herewith, entitled “WATER DISINFECTION DEVICE CONFIGURATIONS AND MATERIALS”, Attorney Docket No. 63NL-320180, the disclosure thereof incorporated by reference herein in its entirety.

### BACKGROUND

The removal of bacteria and other harmful organisms from water is an important process, not only for drinking and sanitation but also industrially as biofouling is a commonplace and serious problem. Further, disinfecting challenge water presents a more difficult task. Challenge water generally contains suspended solids (SS), dissolved solids (DS), or other hard substances that need to be removed. Conventional methods for water sterilization suffer from certain deficiencies.

UV light can sanitize water to some degree. However, it is not effective in treating SS water. Ozone can be used to treat water, but potentially produce harmful byproducts in DS water, such as bromate. Chlorination is typically a slow process, involving incubation times up to an hour or more to allow chlorine species to adequately dissipate through water to be treated. Also, chlorination can yield hazardous oxidation byproducts, including carcinogenic species. Chlorination equipment can be capital intensive, both from the standpoint of deployment and maintenance. Chlorine can produce harmful byproducts in SS water, such as chloroform.

### SUMMARY

Described herein are apparatus and processes for disinfecting water or other liquid for drinking and industrial uses.

In general, one aspect disclosed features an apparatus comprising: a power source configured to supply power to at least two planar electrodes enclosed in a water filtering apparatus, wherein the power source is configured to provide a fixed voltage to the at least two planar electrodes.

Embodiments of the may include one or more of the following features. In some embodiments, the power source is configured to limit current to the at least two planar electrodes to be below a current limit threshold. In some embodiments, power source is configured to fix the current at the current limit threshold responsive to the current reaching the current limit threshold. In some embodiments, a first one of the planar electrodes is of a first material; and a second one of the planar electrodes is of a second material; wherein the first material is different from the second material.

In general, one aspect disclosed features an apparatus comprising: a power source configured to supply power to at least two planar electrodes enclosed in a water filtering apparatus, wherein the power source is configured to provide a constant current to the at least two planar electrodes.

Embodiments of the apparatus may include one or more of the following features. Some embodiments comprise a power source configured to supply power to at least two planar electrodes enclosed in a water filtering apparatus, wherein the power source is configured to provide a periodic voltage waveform between the at least two planar electrodes. In some embodiments, a first one of the planar electrodes is of a first material; and a second one of the planar electrodes is of a second material; wherein the first material is different from the second material. In some embodiments, the first material is copper; and the second material is stainless steel. In some embodiments, the first material is copper; and the second material is carbon felt. In some embodiments, the periodic voltage waveform is one of: a square waveform, a sine waveform, a triangular waveform, or a pulse train. In some embodiments, the periodic voltage waveform has one of: a zero average voltage component, a positive average voltage component, or no negative voltage component. In some embodiments, the at least two planar electrodes are of the same material. In some embodiments, the first material is graphite; the second material is copper or graphite; and the power source provides a first voltage to the first one of the planar electrodes and a second voltage to the second one of the planar electrodes, wherein the first voltage has a positive polarity with respect to the second voltage.

In general, one aspect disclosed features a method for operating an apparatus comprising a power source and a water filtering module comprising at least two planar electrodes arranged in parallel, the method comprising: supplying power from the power source to the at least two planar electrodes, wherein the power provides a periodic voltage waveform between the at least two porous planar electrodes; and directing water through the at least two planar electrodes and the at least one planar separator.

Embodiments of the method may include one or more of the following features. In some embodiments, supplying power further comprises: limiting current to the at least two planar electrodes to be below a current limit threshold. In some embodiments, supplying power further comprises: fixing the current at the current limit threshold responsive to the current reaching the current limit threshold. In some embodiments, supplying power further comprises: providing a constant current to the at least two planar electrodes. In some embodiments, the periodic voltage waveform is one of: a square waveform, a sine waveform, a triangular waveform, or a pulse train. In some embodiments, the periodic voltage waveform has one of: a zero DC voltage component, a positive DC voltage component, or no negative voltage component.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a schematic diagram illustrating a water disinfection apparatus having electrodes of a single material according to some embodiments of the disclosed technologies.

FIG. 2 is a schematic diagram illustrating a water disinfection apparatus having electrodes of multiple materials according to some embodiments of the disclosed technologies.

FIG. 3 is a flow chart illustrating a process for operating a water disinfection apparatus according to some embodiments of the disclosed technologies.

FIGS. 4-7 illustrate example waveforms that may be used in various embodiments.

FIG. 4 illustrates a square wave with a zero DC voltage component.

FIG. 5 illustrates a square wave with a positive DC voltage component, also referred to herein as “Partial AC”.

FIG. 6 illustrates a square wave with no negative voltage component, also referred to herein as “Half AC”.

FIG. 7 illustrates a pulse train.

### DETAILED DESCRIPTION OF EMBODIMENTS

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to an apparatus for disinfecting water and other liquids for drinking and industrial uses. The water filters may be modularized such that the capacity and ability to filter water can be easily expanded.

Because challenge water contains SS, DS, and other hard substances, the electric conductivity in challenge water is generally higher than soft water. Particular consideration is paid to design electrical water filters to treat the challenge water.

### EXAMPLE I

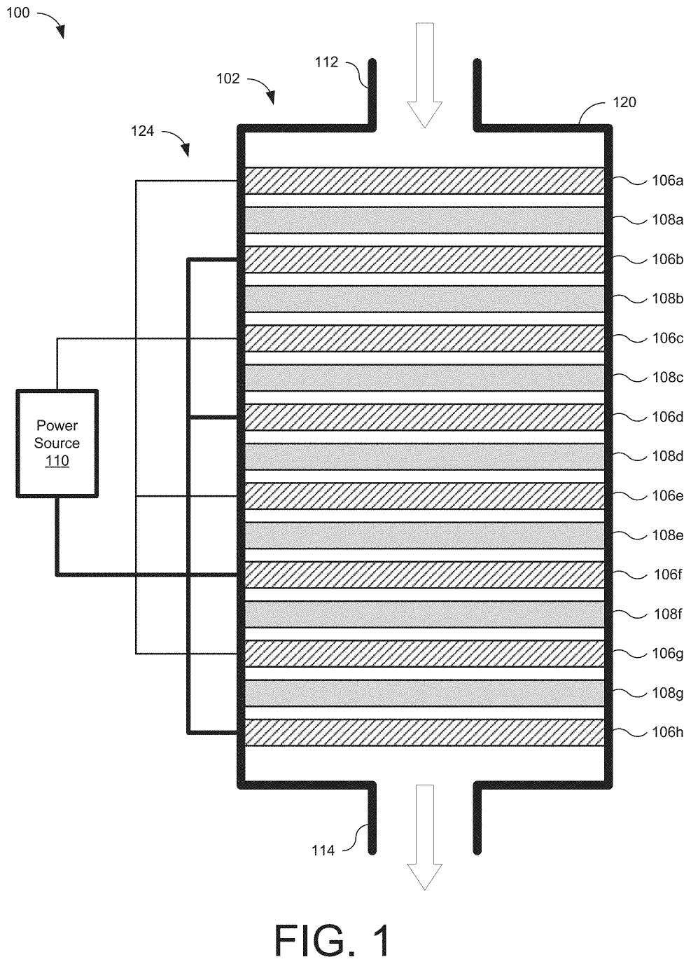

Embodiments will now be explained with the accompanying figures. Reference is made to FIG. 1. FIG. 1 is a schematic diagram illustrating a water disinfection apparatus 100 having electrodes of a single material according to some embodiments of the disclosed technologies. The apparatus 100 includes a water filtering module 102 and a power source 110.

The water filtering module 102 includes at least two electrodes (106a-106h, collectively 106). The electrodes may be porous or non-porous. Challenge water generally has a high electric conductivity. When two electrodes are placed close to each other, challenge water may cause an electrical short therebetween and inhibit the effectiveness of the electrodes in disinfecting the water. In some embodiments, the water filtering module 102 includes at least one separator (108a-108g, collectively 108). Each separator 108 is disposed between two of the electrodes 106. In FIG. 1, eight electrodes 106a,b,c,d,e,f,g,h and seven separators 108a,b,c,d,e,f,g are illustrated. In other embodiments, the separators may be omitted.

Although the water filtering module 102 is illustrated to have eight electrodes and seven separators in FIG. 1, the present disclosure is not so limited. More or fewer electrodes and separators can be include in a water filtering module based on needs and its applications.

The electrodes 106 and the separators 108 are housed in a case 120 of the water filtering module 102. The case 120 may be configured to direct water through the planar electrodes 106 and the planar separators 108. The case 120 may include an inlet 112 to receive water and an outlet 114 to discharge the water.

Materials for the case 120 are selected such that they are water leakage-proof, resistant to water, safe to drink, durable, and of high mechanical strength. For example, the materials for the case 120 may be selected from a group containing silicone, plastics (e.g., ABS), rubber, and other suitable materials that have the above characteristics.

The case 120 may be formed by methods such as injection molding, insert molding, or preforming. The electrodes and separators may be sealed in the case 120 with mechanical structures, such as threads, snaps, screws, etc. They may be secured in the case 120 by adhesives, glues, or ultrasonic welding.

The water disinfection apparatus 100 further includes a power source 110. The power source 110 is coupled to and configured to supply power to the electrodes 106. In one embodiment, the power source 110 supplies a voltage to the electrodes 106. This increases effectiveness in disinfecting water under treatment. For example, the power source 110 can be tuned to provide suitable power to the electrodes depending on the water quality, the size, aging, materials of the electrodes and separators, etc.

The electrodes 106 may be connected to the power source 110 via electrical outlets 124. The electrical outlets 124 may be of conductive materials that are water resistant. For example, the materials may include stainless steel, copper, gold, platinum, etc. The electrical outlets 124 may be shaped to one of a foam extension, a wire, a needle, a sheet, or a bulk. The electrical outlets 124 may be connected to the electrodes 106 by clip mechanisms, welding, soldering, pressing, penetration, etc.

In the example of FIG. 1, all of the electrodes 106 may be of the same material. For example, the material may be Copper, stainless steel, brass, bronze, titanium, carbon felt, graphite foil, carbon nanotube, or similar materials. Alternating ones of the electrodes 106 electrodes may be connected to opposite polarities of the power source 110, as illustrated. The polarities may be reversed.

### EXAMPLE II

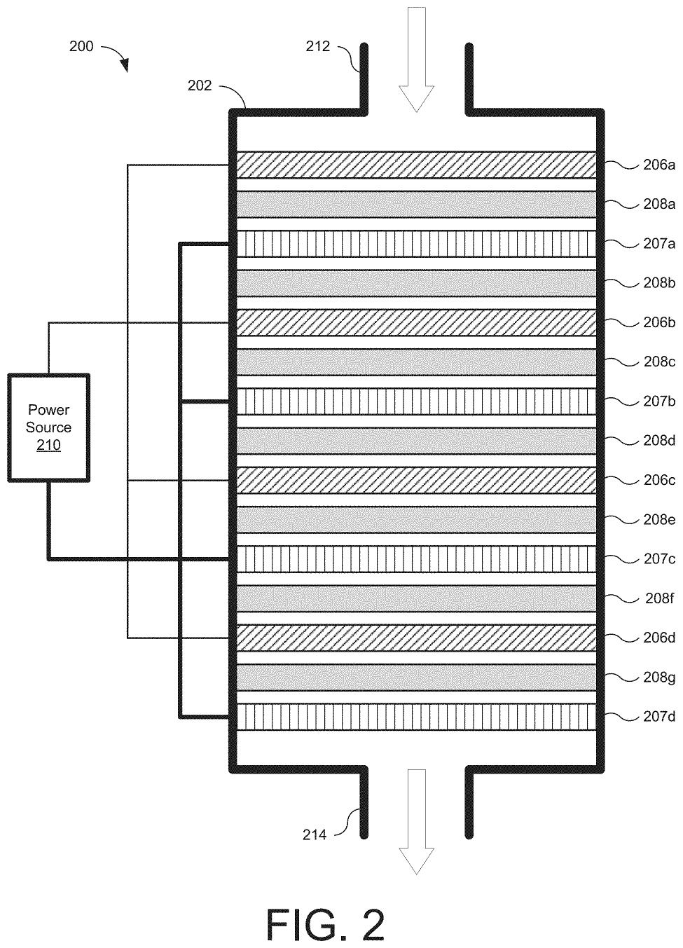

Reference is now made to FIG. 2. FIG. 2 is a schematic diagram illustrating a water disinfection apparatus 200 having electrodes of multiple materials according to some embodiments of the disclosed technologies. The apparatus 200 includes a water filtering module 202 and a power source 210.

The water filtering module 202 includes at least one first electrode (206a-206d, collectively 206), and at least one second electrode (207a-207d, collectively 207). The electrodes 206,207 may be disposed in an alternating manner, as illustrated.

In some embodiments, the water filtering module 202 may include at least one separator (208a-208g, collectively 208). Each separator 208 is disposed between two of the electrodes 206, 207. In FIG. 2, four first electrodes 206a,b,c,d, four second electrodes 207a,b,c,d, and seven separators 208a,b,c,d,e,f,g are illustrated. In other embodiments, the separators may be omitted.

Although the water filtering module 202 is illustrated to have eight electrodes and seven separators in FIG. 2, the present disclosure is not so limited. More or fewer electrodes and separators can be include in a water filtering module based on needs and its applications.

In the example of FIG. 2, the electrodes 206 may be of a different material than the electrodes 207. For example, the materials may include copper, stainless steel, brass, bronze, titanium, carbon felt, graphite foil, carbon nanotube, or the like. The electrodes 206 may be connected to a polarity of the power source 110 opposite to that connected to the electrodes 207, as illustrated.

The electrodes 206 and the separators 208 are disposed in a case 220 of the water filtering module 202. The case 220 may include an inlet 212 to receive water and an outlet 214 to discharge the water. Materials for the case 220 may be similar to those for the case 120 of FIG. 1. The case 220 may be formed by methods similar to those for the case 120 of FIG. 1. The electrodes and separators may be sealed in the case 220 in a manner similar to that for the water filtering module 102 of FIG. 1.

The water disinfection apparatus 200 further includes a power source 210. The power source 210 is coupled to and configured to supply power to the electrodes 206, 207. In one embodiment, the power source 210 supplies a voltage to the electrodes 206, 207. The power source 210 may be tuned to provide suitable power to the electrodes depending on the water quality, the size, aging, materials of the electrodes and separators, etc. The electrodes 206,207 may be connected to the power source 210 via electrical outlets 224 in a manner similar to that for the water filtering module 102 of FIG. 1.

### FURTHER EXAMPLES

The disclosed technology may be applied to many other water disinfection apparatus configurations and materials. For example, the disclosed technology may be applied to the configurations described in related U.S. Patent Application No. TBD, filed concurrently herewith, entitled “WATER DISINFECTION DEVICE CONFIGURATIONS AND MATERIALS”, Attorney Docket No. 63NL-320180, the disclosure thereof incorporated by reference herein in its entirety.

Operation

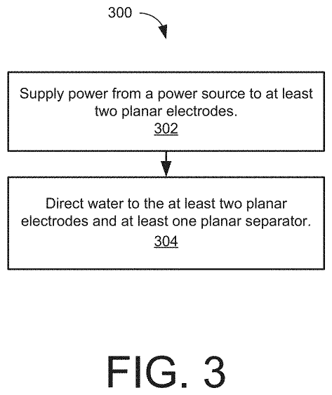

Example methods for operating the disclosed water disinfection apparatuses are now described. FIG. 3 is a flow chart illustrating a process 300 for operating a water disinfection apparatus according to some embodiments of the disclosed technologies. While elements of the disclosed processes are presented in a particular arrangement, it should be understood that one or more elements may be performed in other arrangements and orders, in parallel, omitted, or the like.

Referring to FIG. 3, the process 300 may include supplying power from a power source to at least two planar electrodes, at 302. In the example of FIG. 1, the power source 110 may supply power to the planar electrodes 106. In the example of FIG. 2, the power source 210 may supply power to the planar electrodes 206,207.

Referring again to FIG. 3, the process 300 may include directing water through the at least two planar electrodes and at least one planar separator, at 304. In the example of FIG. 1, the water may be directed through the planar electrodes 106 and the planar separators 108. In the example of FIG. 2, the water may be directed through the planar electrodes 206,207 and the planar separators 208.

In some embodiments, the power source applies a fixed DC voltage across the electrodes. Table 1 presents example disinfection results for a fixed DC voltage, and water quality of CaCL₂+NaHCO₃ at 200 ppm, for flow rates of 0.5 L/min, 1.5 L/min, and 3.0 L/min.

TABLE 1

| Water | | Electrode | Disinfection Results | | |
|---|---|---|---|---|---|
| Quality | Power | Material(s) | 0.5 L/min | 1.5 L/min | 3.0 L/min |
| CaCL₂ + | DC | Carbon-based | Good | Good | Good |
| NaHCO₃ | | Material #1 | | | |
| 200 ppm | | Material #1 | Good | Good | Good |
| | | (+) | | | |
| | | Metal-based | | | |
| | | Material #2 | | | |
| | | (−) | | | |
| | | Material #1 | — | — | — |
| | | (−) | | | |
| | | Material #2 | | | |
| | | (+) | | | |

As shown in Table 1, good water disinfection is achieved for all flow rates when all of the electrodes are made of graphite. Good water disinfection is also achieved for all flow rates when some of the electrodes are made of carbon-based materials, and some are made of metal-based materials, but only when the carbon-based electrodes receive voltage having a polarity that is positive with respect to the polarity applied to the metal-based electrodes.

In some embodiments, the power source is configured to limit current to the at least two planar electrodes to be below a current limit threshold. In some embodiments, the power source is configured to fix the current at the current limit threshold responsive to the current reaching the current limit threshold.

In some embodiments, the power source applies a fixed DC current to the electrodes. Table 2 presents example disinfection results for three different fixed DC currents (1, 2 and 3), water quality of CaCL₂+NaHCO₃ at 200 ppm, for flow rates of 0.5 L/min, 1.5 L/min, and 3.0 L/min, with carbon and metal-based electrodes.

TABLE 2

| | Electrode | | Disinfection Results | | |
|---|---|---|---|---|---|
| Water Quality | Materials | Current | 0.5 L/min | 1.5 L/min | 3.0 L/min |
| CaCL₂ + | Material #1 | #1 | Good | — | |
| NaHCO₃ | (+) | #2 | Good | Good | — |
| 200 ppm | Material #1 | | | | |
| | (−) | #3 | Good | Good | — |

As shown in Table 2, good water disinfection is also achieved for all three current levels at a flow rate of 0.5 L/min, and for current levels of #2 and #3 at a flow rate of 1.5 L/min when the carbon-based electrodes receive voltage having a polarity that is positive with respect to the polarity applied to the metal-based electrodes.

In some embodiments, the power source provides a periodic voltage waveform. in various embodiments, the periodic voltage waveform may be a square waveform, a sine waveform, a triangular waveform, a pulse train, or the like. In various embodiments, the periodic voltage waveform may have particular DC components.

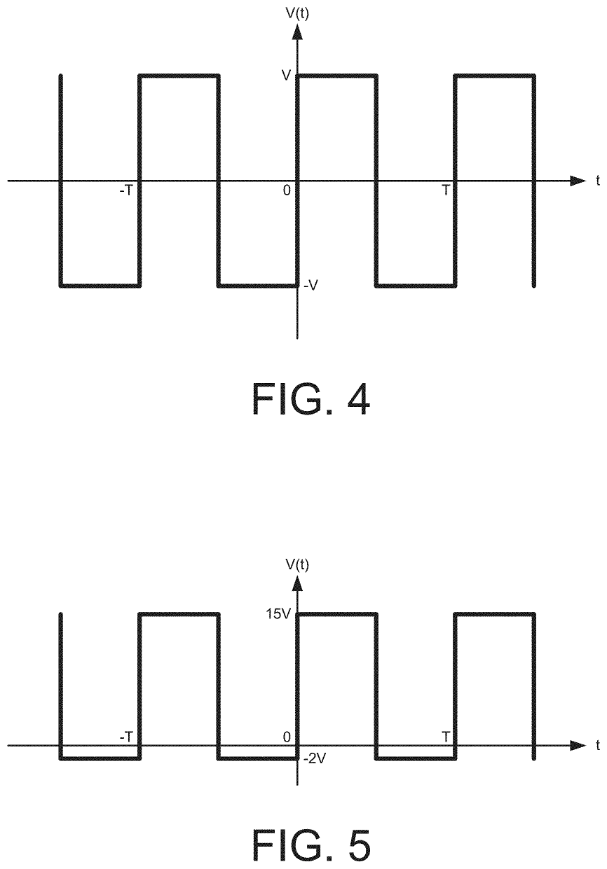

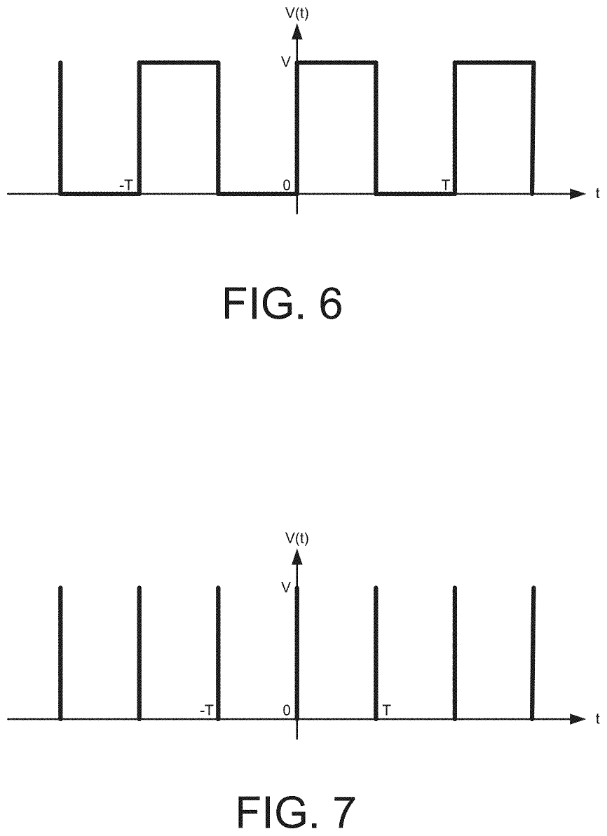

FIGS. 4-7 illustrate example waveforms that may be used in various embodiments. FIG. 4 illustrates a square wave with a zero DC voltage component. FIG. 5 illustrates a square wave with a positive DC voltage component, also referred to herein as “Partial AC”. FIG. 6 illustrates a square wave with no negative voltage component, also referred to herein as “Half AC”. FIG. 7 illustrates a pulse train. Other waveforms may be used. In some embodiments, waveform frequencies in the range 0.5-10 Hz may be used.

Table 3 presents example disinfection results for both DC and Half AC voltages, for flow rates of 0.5 L/min, 1.5 L/min, and 3.0 L/min, with 2 different electrodes.

TABLE 3

| Electrode | Drive | Disinfection Results | | |
|---|---|---|---|---|
| Materials | Signal | 0.5 L/min | 1.5 L/min | 3.0 L/min |
| Metal material | DC | Good | Good | Good |
| #2 (+) | Half AC | Good | Good | Good |
| (Metal-based) | | | | |
| material #3 (−) | | | | |

As shown in Table 3, good water disinfection is achieved for all flow rates and both voltages when the metal-based electrodes receive voltage having a polarity that is positive with respect to the polarity applied to the different metal-based electrodes.

Table 4 presents example disinfection results for both DC and Half AC voltages, for flow rates of 0.5 L/min, 1.5 L/min, and 3.0 L/min, with non-metal material.

TABLE 4

| Electrode | Drive | Disinfection Results | | |
|---|---|---|---|---|
| Materials | Signal | 0.5 L/min | 1.5 L/min | 3.0 L/min |
| Material #2 (+) | DC | Good | Good | Good |
| (carbon-based) | Half AC | Good | Good | Good |
| Material #4 (−) | | | | |

As shown in Table 4, good water disinfection is achieved for all flow rates and both voltages when the metal-based electrodes receive voltage having a polarity that is positive with respect to the polarity applied to the carbon-based electrodes.

Metal leaching may occur in some cases. Table 5 presents metal leaching results for both DC and Half AC voltages, for flow rates of 0.5 L/min, 1.5 L/min, and 3.0 L/min, with metal-based electrodes.

TABLE 5

| Electrode | Drive | Metal Leaching | | |
|---|---|---|---|---|
| Materials | Signal | 0.5 L/min | 1.5 L/min | 3.0 L/min |
| Material #2 (+) | DC | High | High | Medium |
| Material #3 (−) | Half AC | Medium | Low | Low |

As shown in Table 5, the use of Half AC reduces metal leaching in comparison with a fixed DC voltage. The use of Partial AC produces similar results. Metal leaching may also be reduced by increasing the flow rate.

Table 6 presents metal leaching results for both DC and Half AC voltages, for flow rates of 0.5 L/min, 1.5 L/min, and 3.0 L/min, with metal and carbon-based electrodes.

TABLE 6

| Electrode | Drive | Metal Leaching | | |
|---|---|---|---|---|
| Materials | Signal | 0.5 L/min | 1.5 L/min | 3.0 L/min |
| Material#2 (+) | DC | Medium | Medium | Medium |
| Material #4 (−) | Half AC | Low | Low | Low |

As shown in Table 6, the use of Half AC reduces metal leaching in comparison with a fixed DC voltage. The use of Partial AC produces similar results. From Tables 5 and 6, it can be seen that the use of carbon-based electrodes reduces metal leaching in comparison with meta-based electrodes.

In some embodiments, a smart power source may be employed to adjust current and/or voltage according to the total dissolved solids (TDS) in the water. For example, for water with low TDS, and therefore low conductivity, the smart power source may employ a relatively high voltage for disinfection. In some of these embodiments, this voltage may be approximately 12V DC. As another example, for water with high TDS, and therefore high conductivity, the smart power source may restrict the current. These embodiments may extend filter lifetime and reduce energy consumption. In some of these embodiments, the current may be limited to a current in the range of 0-3000 mA at voltages in a range of 1-100 VDC. Table 7 presents example disinfection results for both of these embodiments, for a carbon-based electrode material, for three different levels of TDS, and for flow rates of 0.5 L/min and 1.5 L/min.

TABLE 7

| | | Disinfection Results | |
|---|---|---|---|
| Water Type | Power Type | 0.5 L/min | 1.5 L/min |
| #1 | Fixed Voltage | Good | Good |
| (~130 ppm TDS) | Fixed Voltage & | Good | Good |
| | Clamped Current | | |
| #2 | Fixed Voltage | Good | Good |
| (~240 ppm TDS) | Fixed Voltage & | Good | Good |
| | Clamped Current | | |
| #3 | Fixed Voltage | Good | Good |
| (~720 ppm TDS) | Fixed Voltage & | Good | Good |
| | Clamped Current | | |

As shown in Table 7, good water disinfection is achieved in all cases.

As described above, in some embodiments, the disclosed separators and electrodes may be porous. In such embodiments, the separators may include a porous polymer or mesh that provide insulation between two adjacent electrodes. For example, the separators may include macro porous polymer, such as polyester. The separators include materials of high hydrophilicity and high permeability to water or to the liquid they are designed to sterilize. In one embodiment, the separators include water-penetrable insulating media.

In some embodiments, materials for the electrodes 106 are selected such that they are hydrophilic or have a high permeability to water or to the liquid they are designed to sterilize.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. An apparatus comprising:
a power source configured to supply power to at least two planar electrodes enclosed in a water filtering apparatus, wherein the power source is configured to provide a fixed voltage to the at least two planar electrodes.

2. The apparatus of claim 1, wherein:
the power source is configured to limit current to the at least two planar electrodes to be below a current limit threshold.

3. The apparatus of claim 2, wherein:
the power source is configured to fix the current at the current limit threshold responsive to the current reaching the current limit threshold.

4. The apparatus of claim 1, wherein:
a first one of the planar electrodes is of a first material; and
a second one of the planar electrodes is of a second material;
wherein the first material is different from the second material.

5. An apparatus comprising:
a power source configured to supply power to at least two planar electrodes enclosed in a water filtering apparatus, wherein the power source is configured to provide a constant current to the at least two planar electrodes.

6. An apparatus comprising:
a power source configured to supply power to at least two planar electrodes enclosed in a water filtering apparatus, wherein the power source is configured to provide a periodic voltage waveform between the at least two planar electrodes.

7. The apparatus of claim 6, wherein:
a first one of the planar electrodes is of a first material; and
a second one of the planar electrodes is of a second material;
wherein the first material is different from the second material.

8. The apparatus of claim 7, wherein:
the first material is copper; and
the second material is stainless steel.

9. The apparatus of claim 7, wherein:
the first material is copper; and
the second material is carbon felt.

10. The apparatus of claim 6, wherein:
the periodic voltage waveform is one of:
a square waveform,
a sine waveform,
a triangular waveform, or
a pulse train.

11. The apparatus of claim 7, wherein:
the periodic voltage waveform has one of:
a zero average voltage component,
a positive average voltage component, or
no negative voltage component.

12. The apparatus of claim 6, wherein:
the at least two planar electrodes are of the same material.

13. The apparatus of claim 7, wherein:
the first material is graphite;
the second material is copper or graphite; and
the power source provides a first voltage to the first one of the planar electrodes and a second voltage to the second one of the planar electrodes, wherein the first voltage has a positive polarity with respect to the second voltage.

14. A method for operating an apparatus comprising a power source and a water filtering module comprising at least two planar electrodes arranged in parallel, the method comprising:
supplying power from the power source to the at least two planar electrodes, wherein the power provides a periodic voltage waveform between the at least two porous planar electrodes; and
directing water through the at least two planar electrodes and the at least one planar separator.

15. The method of claim 14, wherein supplying power further comprises:
limiting current to the at least two planar electrodes to be below a current limit threshold.

16. The method of claim 15, wherein supplying power further comprises:
fixing the current at the current limit threshold responsive to the current reaching the current limit threshold.

17. The method of claim 14, wherein supplying power further comprises:
providing a constant current to the at least two planar electrodes.

18. The method of claim 14, wherein:
the periodic voltage waveform is one of:
a square waveform,
a sine waveform,
a triangular waveform, or
a pulse train.

19. The method of claim 18, wherein:
the periodic voltage waveform has one of:
a zero DC voltage component,
a positive DC voltage component, or
no negative voltage component.
